(19) United States
(12) Patent Application Publication
(10) Pub. No.: US 2016/0195798 A1
(43) Pub. Date: Jul. 7, 2016

(54) CAMERA MOUNT FOR SELF-VIDEO RECORDING

(71) Applicant: Valeriy Nenov, Los Angeles, CA (US)

(72) Inventor: Valeriy Nenov, Los Angeles, CA (US)

(21) Appl. No.: 14/707,304

(22) Filed: May 8, 2015

Related U.S. Application Data
(60) Provisional application No. 62/099,148, filed on Jan. 1, 2015.

(51) Int. Cl. G03B 17/56; H04N 5/225

(52) U.S. Cl. CPC G03B 17/561; H04N 5/2251

(57) ABSTRACT

A camera mount system for taking selfie video or photography includes a harness configured to secure to a user's back, a spine pole mounted on the harness and extending upwardly above a user's head, a pivoting mechanism connected to an upper end of the spine pole, and a swivel pole mounted to the pivoting mechanism such that the swivel pole can swivel relative to the pivoting mechanism. The swivel pole further includes a first camera attachment and a second camera attachment. The first camera attachment and the second camera attachment have a vibration isolation system. The harness is a backpack because it further includes a cargo cavity. A first camera can be mounted to the first camera attachment, and a balancing weight can be mounted to the second camera attachment. Wire rope, tensioners and side-mounted stabilizing poles with weights can increase static and dynamic balance.

This application is a nonprovisional continuation in part of and claiming priority from U.S. provisional application 62/099,148 filed Jan. 1, 2015, with same title Camera Mount for Self-Video Recording and same inventor Valeriy I. Nenov the disclosure of which is incorporated herein by reference.

### DISCUSSION OF RELATED ART

The present invention is in the field of camera mounting equipment for videography and cinematography. More specifically it describes a mounting device for DSLR or other small action cameras and smartphones and a method for recording video of oneself or a small group of people in close proximity while performing a variety of indoor and outdoor activities such as walking, hiking, dancing, riding, skating, skiing, etc.

Taking pictures of oneself unassisted by another person is known as “taking a selfie” a.k.a. self recording from a third person's point of view. These kinds of photography and videography have become increasingly popular with the wide usage of smartphones such as iPhone or Android phones as well as the usage of specialized DSLR (Digital Single-Lens Reflex) cameras as the GoPro devices and the Sony series of action cameras.

In general when taking a selfie one needs to have a camera mounted on a device, which allows it to be positioned at a distance from oneself while pointing the camera at oneself. For this purpose multiple mounting devices have been designed and are commercially available. Each one of those mounts has its intended usage and limitations.

The prior art in the field of selfie-specific mounting devices includes: handheld selfie sticks [1], selfie sticks mounted on backpacks [2,17] or special body harnesses [3], and swivel mounts on helmets [4]. For instance, the GoPro camera mounts, which feature sticks mounted either directly on backpacks or on harness belts, while relatively simple and inexpensive, allow only for pre-fixed angles of view during the activity. Due to their physical limitations and design constrains, such as the sticks usually being very short, videos taken with such systems often distort the body proportions and provide cropped views of oneself. In the case of the swivel camera mount, a telescopic stick is mounted in a balanced way on top of a helmet using a ball bearing module, which allows for 360 degrees real-time rotations. While this design provides additional flexibility it has the limitation of requiring a helmet, which makes it useful only in relatively limited set of circumstances and is specifically suited to extreme sports. Remote controlled, wrist-mounted, self video capturing devices have also been proposed [5]. Due to the close proximity of the wrist-mounted camera to the rest of the body these devices also provide mostly very incomplete and distorted views of oneself Body-mounted, actor-pointed, camera support devices have been invented since the 80s (e.g., [6]) and are widely used in the film industry by professional cameramen as well as amateur videographers. Rotating camera mounts with counterbalance have also been proposed and are in use [7].

Additionally, various camera cranes and rigs are commonly used in the filed of professional cinematography. These devices often feature a fixed-size or extendable telescopic arm [8] balanced on a pivoting point, which is mounted on a supporting structure. They are usually very expensive and require one or more crane operators to control them. By design they are used to video record actors in action and the cameras are not pointed to the camera operators, i.e. they are not “selfie” mounts.

The following list of references show elements of the present invention and are cited in the specification. The list of references provide a source of background information for understanding the field of the invention and are hereby incorporated herein by reference.
[1] K. SCAROLA, “Telescoping monopod camera holding apparatus and method,” US20130010186 A1, 10 Jan. 2013.
[2] “Worlds first 3rd Person Perspective POV Camera Mount/GoPro,” Kickstarter. https://www.kickstarter.com/projects/vuvantage/pov-action-camera-pack-mount-forgopro-contour-oth.
[3] “3rd Person View camera mount for action cams, GoPro and DSLR by Erik Vonk—Kickstarter.” https://www.kickstarter.com/projects/erikvonk/3rd-person-view-action-camcamera-mount-for-extrem-0.
[4] “Rhino GoPro Accessories: 360 Swivel & Poles for GoPro Camera by Kyle Hart—Kickstarter.” https://www.kickstarter.com/projects/rhinocg/rhino-gopro-accessories-360-swivel-and-poles-for-g.

[5] S. Yuen and S. Yuen, “Remote-control battery powered rain resistance self-video capturing camera mounting device,” US20030193588 A1, 16 Oct. 2003.
[6] R. E. Gottschalk, F. Navarro, and C. F. Fazekas, “Body-mounted camera support apparatus,” U.S. Pat. No. 4,158,489 A, 19 Jun. 1979.
[7] S. M. Greenthal, “Rotating camera mount with counterweight,” U.S. Pat. No. 8,831,415 B2, 9 Sep. 2014.
[8] L. T. Chapman, “Telescoping camera crane,” U.S. Pat. No. 8,702,327 B2, 22 Apr. 2014.
[9] Hague K3 Mini Jib Traveller Camera Crane. 2014.
[10] Camera Jib Crane for GoPro, iPhone & Pocket Cam's—BoomBandit Review. 2013.
[11] “The Pop and Lock—A folding camera support built for travel,” Kickstarter. https://www.kickstarter.com/projects/2120229387/the-pop-and-lock-a-folding-camerasupport-built-fo.
[12] “Infinity Arm for GoPro, DSLR, and Professional Cameras,” Kickstarter. https://www.kickstarter.com/projects/infinityarm/infinity-arm-for-gopro-dslr-andprofessional-camer.
[13] “Stratus Productions—Vibration Dampeners.” http://www.stratusproductions.com/vibration-dampeners.
[14] “EasyGimbal: An advanced GoPro 3/GoPro 3+ camera stabilizer,” Kickstarter. https://www.kickstarter.com/projects/48127572/easygimbal-an-advanced-gopro-3-camerastabilizer.
[15] “EasyGimbal—A next generation stabilizer.” http://easygimbal.com/.
[16] “XPG Brushless Gimbal for GoPro Hero 2/3 by XPROHELI,” Kickstarter. https://www.kickstarter.com/projects/hansskjersaa/xpg-brushless-gimbal-for-gopro-hero-2-3-by-xprohel.
[17] “CU2PACK” Backpack mounting system for GoPro and action cameras by Wizmount. http://www.wizmount.com/products/cu2pack/

### BRIEF SUMMARY OF THE INVENTION

The present invention features the camera mount device—a device for mounting of small DSLR cameras and smart phones for the purpose of recording videos of oneself from 360 degrees angle and high and low point of view without the assistance of another person. The mounting device is comprised of a vertical pole (a.k.a. spine pole) secured to the back of the user with a harness or backpack and protruding above the user's head to approximately arms length and a horizontal pole assembly (a.k.a. swivel pole) centered on a pivoting assembly on top of the spine pole and aligned with the vertical axis of the user. One or more cameras are mounted at the end points of the swivel and the swivel is balanced over the head of the user. The cameras are pointed towards the user so that the user appears in a centered or an eccentric position within the field of view of each camera. Shock absorption and safety features are provided as well as several features designed to diversify the video self-recording experience. A method for safe and user friendly operation of the camera mount device is also described. The present invention, is a camera mount device that can be sold under a trademark such as CamBrella™ or GoSelfie™, and is designed to overcome several limitations of current camera mounting technologies geared towards taking videos of oneself. Specifically, unlike handheld selfie sticks, it provides hands-free video recording. Unlike helmet-mounted cameras on swivel poles, it provides helmet-free operation allowing the entire body of the person using the camera mount device to be visible by the camera(s). Unlike rigid backpack or harness-mounted solutions, it allows for 360 degrees real-time rotation of the camera(s) around oneself while recording. Furthermore, it allows for easy adjustment of the distance of the camera(s) to the person using the Camera mount device thus enabling close or more distant shots without significant distortion of the person's body proportions, which occurs commonly with wide angle and fisheye lenses used by DLSR cameras.

In addition, the present invention provides for self video recording from: low and high points of view (POV); 360 degrees continuous rotational self video recording with a clockwise (CW) or counter-clock-wise (CCW) direction of camera rotation; centered or eccentric positioning of oneself in the video frame with constrained randomness of the amount of eccentricity; remote control of the angle and rotation speed of the cameras; oscillating swivel of the cameras smoothly transitioning the view of oneself from extreme left via centered to extreme right in the FOV and in reverse; and simultaneous usage of more than one camera for left and right or back and front and low and high views. In addition, by being firmly attached to the body of the person who is recording herself, the camera mount device closely follows any subtle motions of the person thus eliciting a more visceral and haptic perception of the action by those watching the recorded video.

The present invention comprises of two major components: 1) spine pole—a vertical supporting pole mounted on a harness or on a backpack. This pole, which starts at the level of the user's waist and extends a few inches above the user's head, is spine-shaped and length adjustable. It is terminated on the bottom with a back-supporting plate and on the top with a swivel ball bearing or other similar pivot. This pole is shaped so that the top terminating pivot ball is aligned with the vertical axis of the person wearing the device. The pivoting point is not more than an arm length above the head of the person. The back plate is located above the waist and secured by polypropylene webbing straps and a plastic buckle in the front of the user's belly. A second set of shoulder straps attached in the back to the middle section of the spine pole is also tightly and securely strapped with a plastic buckle in front of the user's chest. An optional third set of plastic straps positioned at the level of the collarbones can be used for further stability. 2) swivel pole—a composite structure comprised of two telescopic monopods attached to a socket—a cap-like structure joining the two monopods, which is centered on top of the spine's pivoting point. Each of the monopods is terminated at the far end with a camera-specific attachment module. At the central section it is securely attached to the pivoting socket.

The camera mount device is designed for usage with action cameras like GoPro or Sony action cams, however it can be also used with smartphones and other relatively lightweight DLSR cameras. Optionally, the camera mount device can be equipped with an electric motor set for rotating the swivel pole or a pair of lightweight oscillating fans mounted at the ends of the swivel pole. An optional wired or wireless device for controlling the direction and speed of the camera rotation can be also used. f

As any device the camera mount device has its intended usage and its usage limitations. It is designed to record oneself, couples or small groups of people in close proximity—within the diameter of the rotating horizontal swivel pole. The preferred embodiment of the camera mount device is suitable for video recording of actions in which the upper body of the user is in an approximately upright position such as walking, riding, etc. With a sufficient back tilt of the spine ankle joint the camera mount device can also be used for video recording of activities in which the upper body is in an approximately horizontal or flat position like swimming, body surfing, boogie boarding, crawling, sled and tube sliding in the snow on your belly, etc. With waterproof cameras the camera mount device can also be used for underwater videography especially while snorkeling and scuba diving. In addition, if the two fans, which can be optionally attached to the ends of the swivel pole and/or to the ends of the balance poles are also waterproof, then the user can take 360 degrees real-time rotational video of herself while swimming under water. The camera mount device is not suitable for usage in big crowds in close proximity since there is a danger of the swivel pole hitting someone, unless the user controls the swivel pole by holding and pulling down one end of it, which reduces the overall foot print of the device. Preferably it should be used in relatively open spaces to reduce the potential danger of the swivel hitting something. In addition, the user should be aware at all times of the span of the swivel pole and its location relative to any persons and objects within the reach of the swivel pole. Also, unlike other solutions which are limited to recording during extreme sports such as snow boarding, skiing, etc., the design of the camera mount device is suitable for video recording of oneself during the conduct of more common everyday activities where the human body is subject to prolonged translational motion such as walking, hiking, riding, etc. However, it is also applicable for activities, which are conducted mostly in small areas but involve interesting actions on part of the user and or interesting change of scene such as dancing surrounded by an audience, working in the backyard or workshop, or cooking in the kitchen, etc.

The camera mount device features a number of built-in safety mechanisms including: 1) Automatic release of the swivel pole socket from the spine pole. This can be implemented in different ways including a magnetic or a screw-type of attachment; 2) Soft wrap of the cameras to reduce the impact of unintentional contact with other persons or objects; 3) An optional, thin lightweight, self-winding, fishing line can connect the swivel pole with the backpack to assure that the swivel pole is not lost if it is accidentally detached from the pivot ball in adverse conditions such as water or winter sports, hiking steep terrains, etc. The fishing line can be coiled and packed on top of the socket and can be connected to the screw cap or magnetic snap described in item #1 above; 4) Easy and sustained balancing over the person's head to prevent back strain due to inertial and centrifugal forces induced by occasional abrupt movements.

The design of the camera mount device provides solutions to several technical challenges including: 1) The reduction and elimination of inherent shaking, vibration and wobbling of the camera(s) during walking, which is due to transfer of shock energy from the feet hitting the ground through the user's body, the spine and swivel modules. 2) The appearance of parts of the camera-mount structure within the visual field of the cameras. 3) Sound isolation. There might be inherent clicking and grinding noises originating from the pivoting mechanism. Therefore, if the user wants to capture good quality sound with the built-in microphones of the cameras, it is essential that a sound isolation mechanism be also provided. 4) Maintaining a horizontal orientation of the cameras' bases within reasonable limits of spinal pole tilts and precessions during intended or unintended swivel pole dips. A number of provisions for solving these challenges are included in the detailed description of this invention.

The main qualities of the camera mount device compared to other competing devices are:

1) Light weight—aluminum and carbon fiber;

2) Compact design—modular structure, which can be folded for easy carrying in a backpack or other carrying bag specifically designed for this purpose or even a general-purpose bag;

3) Easy to assemble and disassemble as well as to put on and take off;

4) Cheap—depends on choice of materials and manufacturer;

5) Durable—depends on the choice materials;

6) Aesthetic design—high quality device with professional look;

7) Safe—magnetic or cap screw and camera cushions as well as easy balance;

8) Stable camera during walk—can be achieved by the use of gyros, wire rope, camera jib or crane [9][10] and wire shock isolator;

9) Minimally obtrusive—transparent harness straps and spine pole and logo hangs to hide the camera mount device structure;

10) Versatile—can be used with different cameras such as GoPro, Sony action cams, smartphones like iPhone, Android and Windows phones, etc.

A camera mount system for taking selfie video or photography includes a harness configured to secure to a user's back, a spine pole mounted on the harness and extending upwardly above a user's head, a pivoting mechanism connected to an upper end of the spine pole, and a swivel pole mounted to the pivoting mechanism such that the swivel pole can swivel relative to the pivoting mechanism. The swivel pole further includes a first camera attachment and a second camera attachment. The first camera attachment and the second camera attachment have a vibration isolation system. The harness is a backpack because it further includes a cargo cavity. A first camera can be mounted to the first camera attachment, and a balancing weight can be mounted to the second camera attachment. A tension wire is suspended above the swivel pole. A side tensioner can extend from the swivel pole to the tension wire to support the tension wire. A tension wire can be suspended above the swivel pole. A central tensioner can extend from the swivel pole to the tension wire to support the tension wire. A swivel rotating mechanism can be configured to rotate the swivel pole relative to the spine pole on the pivoting mechanism. A remote control can control the swivel rotating mechanism. The swivel rotating mechanism can be a pair of fans. A method of mounting and using a camera can include the steps of assembling of a camera mount device that includes: a harness configured to secure to a user's back; a spine pole mounted on the harness and extending upwardly above a user's head; a pivoting mechanism connected to an upper end of the spine pole; and a swivel pole mounted to the pivoting mechanism such that the swivel pole can swivel relative to the pivoting mechanism. The method may also include the step of adding a first camera attachment and a second camera attachment to the swivel pole. The method may also include adjusting and balancing a swivel pole for a desired point of view and then recording a selfie video. The method may also include the step of including a vibration isolation system on the first camera attachment and the second camera attachment. The method may also include the step of including a cargo cavity on the harness so as to provide a backpack for the user. The method may also include the step of mounting a first camera to the first camera attachment, and mounting a balancing weight to the second camera attachment. The method may also include the step of suspending a tension wire above the swivel pole, wherein a side tensioner extends from the swivel pole to the tension wire to support the tension wire.

### BRIEF DESCRIPTION OF THE DRAWINGS

FIG. 1 is a side perspective view of a user operating the camera mount device.

FIG. 2 is a front perspective view of a user operating the camera mount device.

FIG. 3 is a front view of the camera mount device.

FIG. 4 is a side view of the camera mount device.

FIG. 5 is a side view of the pivot module of the camera mount device.

The following call out list of elements can be a useful guide in reference to the element numbering of the drawings and can also function as a parts list for building the camera mount device present invention.
Backpack Or Harness 100
Spine Pole 110
Pivoting Mechanism 120
Swivel Pole 130
Camera Attachments 140
Cameras 150
Small Balancing Weights 160
Floatation Tubes And Pads 161
Vibration Isolation System 162
Mechanical Or Wireless Remote Control 163
Cargo Cavity 164
Tension Wire Rope 170
Side Tensioners 180
Central Tensioner 190
Low Angle 200
High Angle 210
Pivoting Mechanism 220
Two Camera Specific Attachments 230
Cameras 240
Logo Plates 250

Optional Side Poles 260
Oscillating Fans 270
LED Lights 280
Backpack Harness 300
Spine Pole 310
Pivot Ball 320
Corresponding Socket 330
Two Mono Pods 340
Backplate 350
Shoulder Straps 360
Chest Strap 370
Belly Strap 380
Plastic Buckles 390
Ankle Hinge 420
Belly Straps 430
Shoulder Straps 440
Plastic Buckles 450
Spine Plate 460
Head And Neck Tube 410
Pivot Ball 470
Plastic Cap 480
Zippered Flap 490
Pivot Module 500
Ball 510
Plastic Or Aluminum Socket 520
Fixed Brackets Or Adjustable Angle Joints 530
Nuts 540
Telescopic Mono Pods 550
Finger Tightening Screws 560
Tube Fittings 570
Wire Rope 580
Tensioners 590
Camera Specific Attachment Adapters 595
Sound Isolating Soft Rubber Or Foam Pads 599

### DETAILED DESCRIPTION OF THE PREFERRED EMBODIMENTS

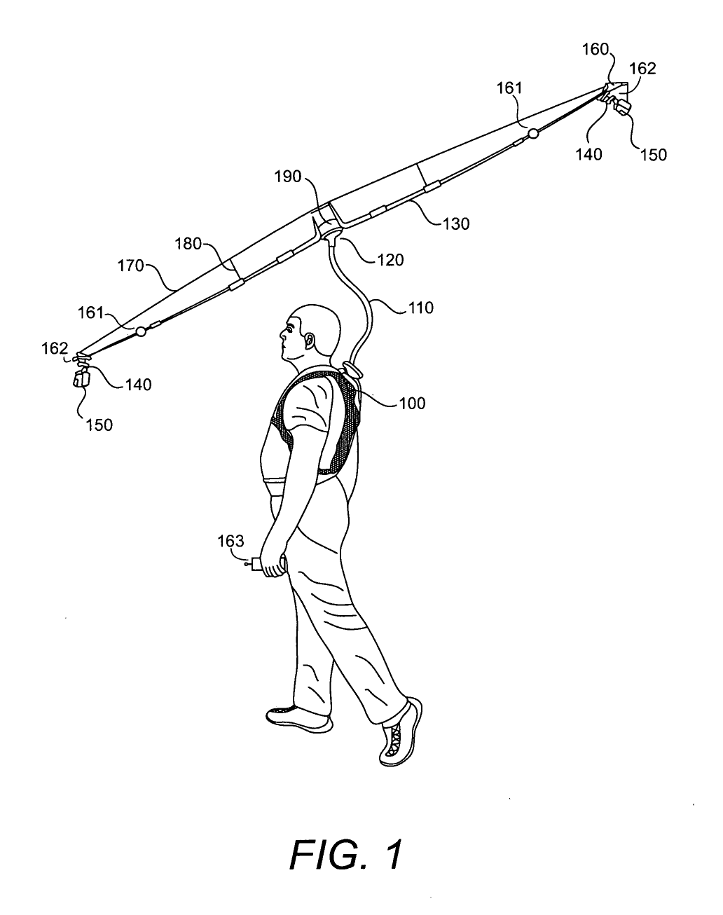

FIG. 1 shows a side view of a person carrying a small size camera mount device (e.g., 8 feet diameter). The camera mount device has a backpack or harness 100; a shape and length adjustable spine pole 110 secured at the bottom of the backpack and extending above the head of the user; a pivoting mechanism 120; a swivel pole 130 having two detachable telescopic monopods (e.g., 3 segments each for the small size camera mount device); and camera attachments 140 at the end of each monopod. A backpack includes a harness with a cargo area such as a cargo cavity 164. The camera attachments 140 can be camera-specific attachments and support both action cameras (e.g., GoPro™ and Sony™), as well as smartphones (e.g., iPhone™ and Android™ phones). The camera attachments can include a gimbal or motorized angle control such as a pan control. The cameras 150 can be packaged and sold separately from the camera mount device package. Also, instead of a second camera an optional balancing weight can be used such as an additional small balancing weight 160 provided for positioning of the swivel pole in a low or high position. Without this weight the swivel pole is horizontally balanced by default. An optional tension wire rope 170 is used to stabilize the swivel pole and to reduce occasional shaking during walking, running, a bumpy ride and other rhythmic activities of the user's body. The tension wire is attached to both ends of the swivel pole and is placed in a tensed state by side tensioners 180. One or more central tensioners 190 are attached to the pivoting mechanism to provide additional sturdiness of the swivel pole.

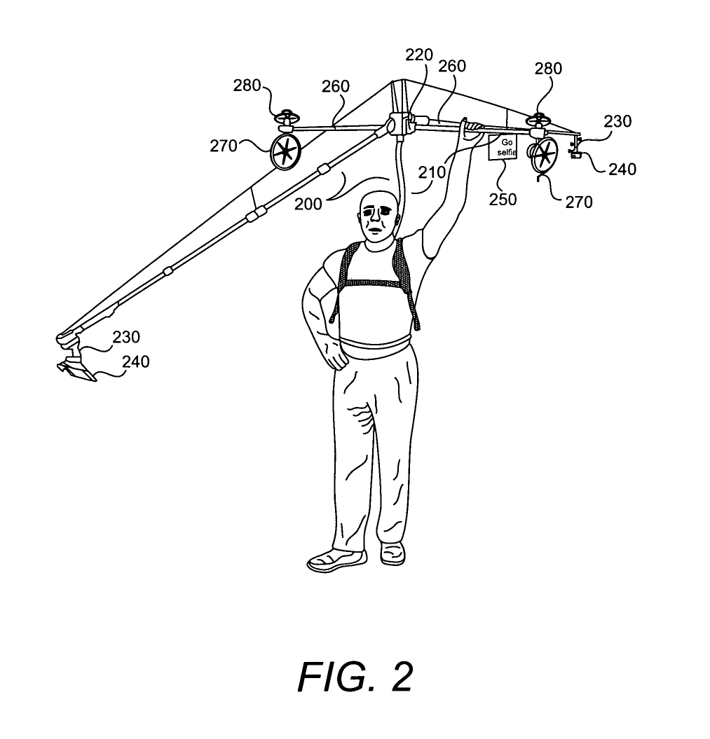

FIG. 2 shows a front view of a person carrying a large size camera mount device equipped with an adjustable angle of the monopods, which forms the swivel pole. A large size camera mount device can be of 12 feet diameter with outwardly extending four segment monopods. FIG. 2 shows the minimal low angle 200 of one of the monopods with respect to the spine pole, and the corresponding high angle 210 for the second monopod. Depending on the desired points of view (POV), the user can selectively set the angles of the monopods at the pivoting mechanism 220. Two camera-specific attachments 230 allow the cameras 240 to be positioned so that the user appears in a centered or eccentric position in the field of view (FOV) of the cameras. Two optional translucent and reflective logo plates 250 can be attached to the monopods in such positions as to obscure the visible parts of the camera mount device in the cameras' FOV (i.e. the top of the spine pole and the pivot mechanism). Two optional side poles 260 are used for additional anti-shaking and wobbling stabilization. These poles can be further used to manually rotate the swivel pole and to position it in a desired direction such as front to back, left to right or optionally at any 360 degree angle. These balance poles can also be used to attach two lightweight battery-powered oscillating fans 270 to provide automatic rotation of the swivel pole. Two optional (light-emitting diode) LED lights 280 pointed at the user for low light and nighttime videography can also be attached to the ends of the balance poles.

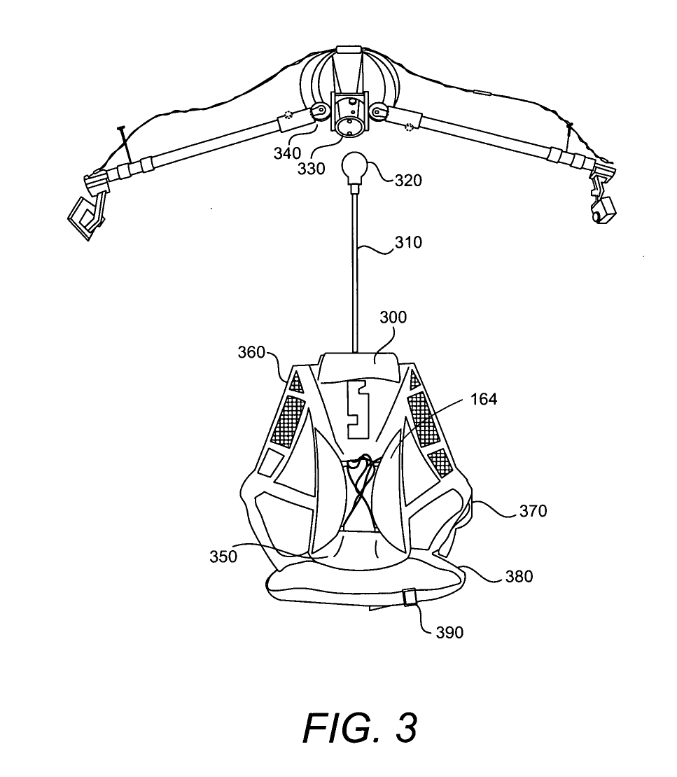

FIG. 3 illustrates a detailed back view of the backpack harness 300 and the spine pole 310. The spine pole is terminated on the top with a pivot ball 320 made of durable hard plastic, aluminum or wood. The design of the pivot ball and the corresponding socket 330 as well as the precise positioning of the joints of the two monopods 340 is such that it enables the maintenance of a horizontal orientation of the cameras' bases at all times. The spine pole is attached on the bottom to a back plate 350, which is placed inside at the bottom of the backpack. Two shoulder straps 360 are used to secure the backpack and harness to the user's back. In one embodiment the harness can be made of translucent straps and can fit under the clothing such as a competition or performance outfit or dress. In addition, two straps including a chest strap 370 and a belly strap 380 are used to tighten the backpack in the front so that the vertical spine pole is firmly aligned with the user's spine. An additional neck strap can be used to further secure the backpack. The straps are terminated with plastic buckles 390 for selective adjustment.

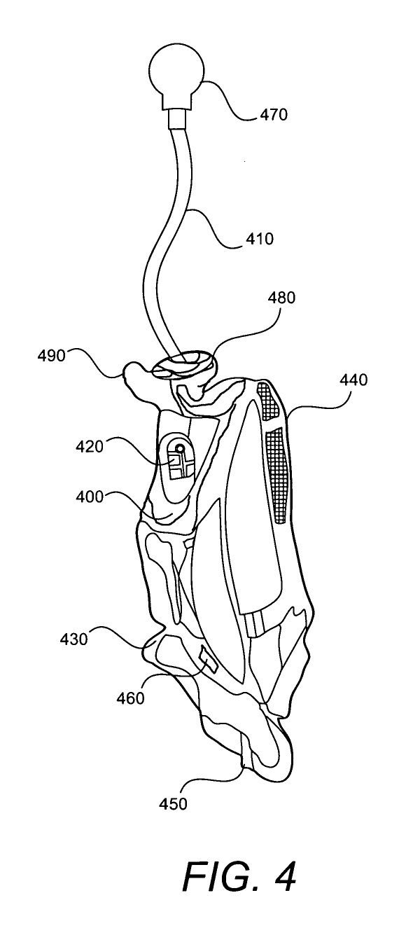

FIG. 4 shows a detailed side view of the spine pole and the backpack. The vertically oriented pole can be adjusted to conform to the shape and length of the person's spine to assure maximum comfort and balance. The pole is constructed of two detachable pieces, namely: 1) a spine tube 400 placed in the backpack; and 2) a head-and-neck tube 410 outside of the backpack. The head-and-neck tube fits snugly into the spine tube. Tubes are used instead of rods to reduce the overall weight. Also, the tubes are sealed at both ends with end caps to provide buoyancy in case the camera mount device is dropped in the water. The spine tube is outfitted with an adjustable angle ankle hinge 420 outfitted with a pop-and-lock knuckle joint [11] or rosette locking [12]. This joint is used to fit and conform the spine pole's shape to the body shape of the user. This is a necessary component since some people have straighter backs than others. Belly straps 430 and shoulder straps 440 are firmly attached to the spine pole directly or via the backpack. They are fastened in front of the user's chest and belly with plastic buckles 450. These straps can also be part of the backpack as seen in FIG. 3. The spine pole can be made of aluminum, plastic, carbon fiber or any other light material and is connected to the spine plate 460, which can be placed inside at the bottom of the backpack in a cargo cavity 164 of the backpack. The head-and-neck tube 410 is curved into an Omega shape to fit the curvature of the human's head. The head-and-neck tube 410 is terminated with a pivot ball 470, which is part of the ball and socket pivot assembly. The head-and-neck part of the spinal pole can be made from a translucent acrylic or plastic tube to reduce its visibility in the cameras' field of view. The plastic tube can be made of polymethylmethacrylate (PMMA), a transparent or translucent thermoplastic that is also marketed under the trademark Plexiglas™. A plastic cap 480 or a magnetic snap can have threads so that they can be threaded onto threads formed on the pole. Alternatively, the plastic cap 480 can be attached to the socket such as by interference fit. The spine part, including the adjustable ankle joint, is placed in the backpack and covered with a zipped flap 490.

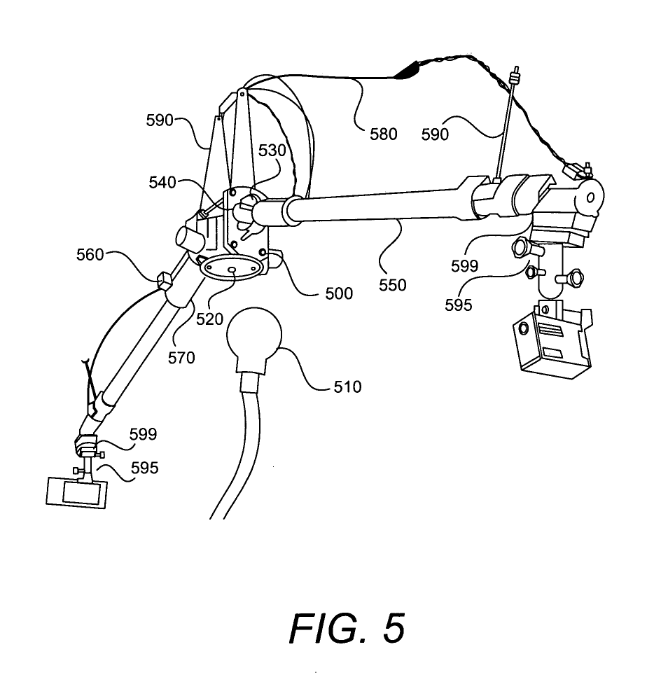

FIG. 5 shows a side view drawing of one embodiment of the pivot module 500, which is attached to the spine pole during the user's assembly of the camera mount device. The pivot module 500 includes: a low friction ball 510; a sturdy plastic or aluminum socket 520 which fits snuggly over the ball; and two fixed brackets or adjustable angle joints 530 firmly attached to the socket at 90 degrees. Dry powdered Graphite or other lubricant can be used between the ball and the socket to minimize friction. The user can fix and adjust the joint angle settings with finger-tightened nuts 540. FIG. 5 shows the telescopic monopods 550 in a collapsed state. The telescopic monopods 550 form the swivel pole, and are attached to the joints with finger-tightening screws 560 and tightly fitting slide-in plastic or aluminum tube fittings 570. After the socket 520 is placed over the ball 510 during the assembly of the camera mount device, the socket 520 is further secured with a plastic screw cap or magnetic component, such as the snap plastic cap 480 of FIG. 4. The snap plastic cap 480 component serves the dual purpose of securing the ball into the socket and as a safety release mechanism in case of accidental impact. In another embodiment the socket and the ball can be permanently attached to each other and the entire pivoting mechanism can be attached to the spine pole. The wire rope 580 is threaded through the central and peripheral tensioners 590 and is attached to the end of the telescopic monopods 550. The camera-specific attachment adapters 595 are also firmly attached to the end of the monopods by sound isolating soft rubber or foam pads 599.

One possible embodiment of a rotation-inducing mechanism for the swivel pole uses an optional electric motor interfaced mechanically to the pivot ball. The rotation-inducing mechanism includes a tensioner, which keeps the rubber rollers of the electric motor in contact with the pivot ball. The engagement state of the rotation-inducing mechanism can be controlled directly by a manual switch or by remote control. Optionally, two small electric fans mounted at the end of the balance poles or at the end of the swivel pole can be used to induce rotation of the swivel pole. In addition to manually controlling the rotation for the swivel pole, another embodiment of a control mechanism can be a handheld, wireless remote control of the electric motor(s) of the central rotation mechanism and/or the peripheral fans. The wireless protocol used can be Bluetooth, Wi-Fi or the like.

A vibration abatement mechanism, also called a vibration isolation system, or a shake or shock arresting mechanism uses a specially configured cable or steel rope wire assembly designed to reduce both vertical and lateral shock impacts originating in the user's body. Similar shock arresting mechanisms are used for mounting small cameras such as GoPro™ cameras onto small drones such as tricopters and quadcopters and the like [13]. Preferably, a vibration reduction system 162 for reducing shakes and wobbles can be formed using two gyroscopic gimbal shock absorption devices as seen in references [14][15][16], which are mounted at the ends of the swivel pole. Gimbals are commonly available for this purpose.

The present invention describes a novel camera mount system and a method for its usage. The present invention is a camera mount device that can be sold under a trademark such as Cambrella™ or Goselfie™.

Materials for manufacturing: Ideally all elements of the camera mount device should be made of very light and sturdy hard to bend materials such as aluminum and carbon fiber tubing. The pivot component should be made of light and sturdy hard plastic or aluminum. Stainless steel can also be used for components as necessary.

Method for usage of the camera mount device:
A. Assembly: Starting with all separate components as they are shipped to the user:
   1) Attach the two monopods, which form the swivel pole, to the pivot mount.
   2) Attach the video camera(s) to the ends of the monopods;
   3) Place the lower part of the spine pole with the back plate in the backpack;
   4) Attach the Omega-shaped upper part of the spine pole to the adjustable ankle joint and set it up according to the user's back shape using a 12 mm wrench.
B. Put-on, Record Media & Take-off:
   1) Position the swivel pole and place it on top of the spine pole and secure it with the cap screw (or magnetic attachment);
   2) Put the harness or backpack on your back and buckle up the straps;
   3) Turn on the cameras and start recording. This can be done later using the remote control 163 if available or the smart phone app for the specific type of camera;
   4) Adjust the lengths of the two monopods forming the swivel pole by stretching the telescopic parts;
   5) Balance the swivel pole in the preferred position for leveled or low/high angle POV recording.
   6) Optionally increase the stability of the swivel pole (i.e. Decrease the shaking especially during walking and other bouncing activities) by attaching and tightening a steel wire rope from one end of the swivel pole to the other.
   7) Do the recording for the desired duration.
   8) Take off the camera mount device by repeating the above steps in reversed order.
   9) Detach the video cameras and review or transmit the recorded videos to a computer for further editing as desired.

Depending on the actual design of the swivel pole and the user's preferences, the order of the afore-mentioned setup steps can be altered if needed. Specifically, the order of the final configuration of the swivel pole and its positioning on top of the spine pole can be reversed. In other words, the swivel pole can be configured before or after it has been mounted on top of the spine pole.

Possible usage of the camera mount device camera mount for video recording of:
1. Single or couple (small group) walking or hiking.
2. Single or couple (small group) dancing, e.g. on stage or on ice.
3. Bond fires, drum circles and other small group gatherings.
4. Birthday parties, candle light dinners and picnics.
5. Petting zoo, walking dogs, doing gardening and other housework.
6. Horseback, donkey, mule, camel, elephant and other large animals riding.
7. Bicycling, motorcycling, go-cart riding solo, tandem and with side basket.
8. Water sports like jet skiing, canoeing, paddle boarding, paddle boating, and underwater videography during snorkeling and scuba diving, etc. Note that to improve sweet water or salt water buoyancy of the detachable swivel pole, which holds the cameras, one or more flotation tubes and pads 161 can be added. Flotation tubes and pads 161 can be floats such as soft foam pads or tubes wrapped around the monopods or attached to the pivoting mechanism.
9. Winter sports like snowboarding and skiing.
10. Interviews with a single person and a small group.
11. Video self-recording for all D.I.Y. projects like cooking in the kitchen, workshop, etc.
12. Tracking over time of personal progress in taking one-on-one private dance lessons. This can significantly improve the efficiency of coaching by enabling students to review their progress in camera mount device recorded videos.
13. Many more activities limited only by the user's imagination and the camera mount device limitations.
14. In addition to taking video of yourself by yourself the CamBrella can be used as a very versatile, smooth and well stabilized steady cam. This can be easily achieved by simply rotating by 180 degrees one or both camera mounts at the ends of the swivel pole from pointing inward towards the user to pointing outward, while at the same time adjusting the angles of the cameras with respect to the swivel pole. In this configuration the user can hold and pull down with one hand one end of the swivel pole, which results in having one of the cameras several feet above the user's head taking video from a “birds eye view” while the other camera is below the waste of the user taking out-looking video from a very low point of view, which can be even at the ground level. In this usage scenario the overall footprint of the CamBrella is significantly reduced, which makes possible its usage in crowds without worrying that the swivel pole might hit someone. Some examples of usage of this configuration are concerts, dance parties, milongas, and all sorts of public gatherings. As in any videography effort, it is up to the user to master the control of the swivel pole in order to obtain the desired video footage.

1) A camera mount system comprising:
a. a harness configured to secure to a user's back;
b. a spine pole mounted on the harness and extending upwardly above a user's head;
c. a pivoting mechanism connected to an upper end of the spine pole;
d. a swivel pole mounted to the pivoting mechanism such that the swivel pole can swivel relative to the spine pole, wherein the swivel pole further includes a first camera attachment and a second camera attachment.

2) The camera mount system of claim 1, wherein the first camera attachment and the second camera attachment have a vibration isolation system.

3) The camera mount system of claim 1, wherein the harness is a backpack because it further includes a cargo cavity.

4) The camera mount system of claim 1, further comprising a first camera mounted to the first camera attachment, and further comprising a balancing weight mounted to the second camera attachment.

5) The camera mount system of claim 1, further comprising a tension wire suspended above the swivel pole, wherein one or more side tensioners extend from the swivel pole to the tension wire to support the tension wire.

6) The camera mount system of claim 1, further comprising a tension wire suspended above the swivel pole, wherein a central tensioner extends from the swivel pole to the tension wire to support the tension wire.

7) The camera mount system of claim 1, further comprising a swivel rotating mechanism, wherein the swivel rotating mechanism is configured to rotate the swivel pole relative to the spine pole on the pivoting mechanism.

8) The camera mount system of claim 7, further including a remote control that controls the swivel rotating mechanism.

9) The camera mount system of claim 7, wherein the swivel rotating mechanism is a pair of fans.

10) The camera mount system of claim 7, wherein the first camera attachment and the second camera attachment have a vibration isolation system.

11) The camera mount system of claim 7, wherein the harness is a backpack because it further includes a cargo cavity.

12) The camera mount system of claim 7, further comprising a first camera mounted to the first camera attachment, and further comprising a balancing weight mounted to the second camera attachment.

13) The camera mount system of claim 7, further comprising a tension wire suspended above the swivel pole, wherein one or more side tensioners extend from the swivel pole to the tension wire to support the tension wire.

14) The camera mount system of claim 7, further comprising a tension wire suspended above the swivel pole, wherein a central tensioner extends from the swivel pole to the tension wire to support the tension wire.

15) The camera mount system of claim 7, further comprising a swivel rotating mechanism, wherein the swivel rotating mechanism is configured to rotate the swivel pole relative to the spine pole on the pivoting mechanism.

16) A method of mounting and using a camera comprising the steps of: assembling of a camera mount device comprising:
a) a harness configured to secure to a user's back;
b) a spine pole mounted on the harness and extending upwardly above a user's head;
c) a pivoting mechanism connected to an upper end of the spine pole;
d) a swivel pole mounted to the pivoting mechanism such that the swivel pole can swivel relative to the pivoting mechanism, wherein the swivel pole further includes a first camera attachment and a second camera attachment; adjusting and balancing a swivel pole for desired point of view; and then recording a selfie video.

17) The method of mounting and using a camera of claim 16, further comprising the step of:
including a vibration isolation system on the first camera attachment and the second camera attachment.

18) The method of mounting and using a camera of claim 16, further comprising the step of:
including a cargo cavity on the harness so as to provide a backpack for the user.

19) The method of mounting and using a camera of claim 16, further comprising the step of:
mounting a first camera to the first camera attachment, and mounting a balancing weight to the second camera attachment.

20) The method of mounting and using a camera of claim 16, further comprising the step of:
suspending a tension wire above the swivel pole, wherein a side tensioner extends from the swivel pole to the tension wire to support the tension wire.

21) The method of mounting and using a camera of claim 16, further comprising the step of:
attaching two optional side balancing poles to the pivoting mechanism to increase the static and dynamic stability of the entire system.

22) The method of mounting and using a camera of claim 16, further comprising the step of:
attaching one or more flotation tubes and/or pads to the swivel pole and the pivoting mechanism to provide sweet and salt-water buoyancy for the detachable swivel pole in water sports videography.

23) The method of mounting and using a camera of claim 16, further comprising the step of:
rotating one or both cameras 180 degrees to point outwards in order to record the user's surroundings without him/her being in the field of view.
